(19) United States
(12) Patent Application Publication
(10) Pub. No.: US 2006/0005766 A1
(43) Pub. Date: Jan. 12, 2006

(54) Ultrasonic standing wave spraying arangement

(75) Inventors: Uwe Gorges, Bochum (DE); Gert Stauch, Wiesloch/Baiertal (DE); Bjorn Matthias, Schonborn (DE); Gunter Borner, Sinsheim-Eschelbach (DE); Hidetoshi Yamabe, Tokyo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: ABB PATENT GMBH, Ladenburg (DE)

(21) Appl. No.: 10/526,546

(22) PCT Filed: Oct. 29, 2003
(86) PCT No.: PCT/EP03/11967

§ 371 Date: Mar. 3, 2005

(30) Foreign Application Priority Data
Nov. 12, 2002 (DE) 102 52 437.8

(51) Int. Cl. B05B 5/025; B05C 5/02

(52) U.S. Cl. 118/621; 118/624

(57) ABSTRACT

The invention relates to an ultrasonic standing-wave atomizer arrangement 10, 40, 50, 60, 70, 80 for producing a paint spray mist for painting a workpiece, with a sonotrode 12, 48 and with a component 14, 46 arranged lying opposite the sonotrode 12, 48. A standing ultrasonic field is formed in the intermediate space between the sonotrode 12, 48 and the component 14 in the case of operation. A paint-feeding device 29, by means of which paint can be fed into the vicinity of a maximum of the sound particle velocity of the ultrasonic field, is provided. The paint-feeding device has in the region of the standing ultrasonic field at least two pieces of pipe 30, 31, 32; 42, 43, 44 for discharging paint, at least two of the pieces of pipe 30, 31, 32; 42, 43, 44 being arranged in the region of a selected maximum of the sound particle velocity of the standing ultrasonic field.

The invention relates to an ultrasonic standing-wave atomizer arrangement for producing a paint spray mist for painting a workpiece, with a sonotrode, with a component arranged lying opposite the sonotrode, a standing ultrasonic field being formed in the intermediate space between the sonotrode and the component in the case of operation, and with a paint-feeding device, by means of which paint can be fed into the vicinity of a maximum of the sound particle velocity of the ultrasonic field.

For painting workpieces, in particular in mass painting as frequently encountered in the automobile industry, at present the generally known high-rotation atomizers are preferably used. In the case of high-rotation atomization, the paint is passed through the interior of a metal bell and in this way reaches the front side of the latter, facing the workpiece. The metal bell is usually driven by a compressed-air turbine and rotates at up to 80 000 revolutions per minute. The centrifugal forces acting in this case then cause the paint to reach the front-side edge of the bell, to break away there in fine droplets. This achieves the effect that the droplet size of the paint spray mist required for adequate quality of a coat of paint lies in the range from 10 μm to 60 μm.

Considerations of the fundamentals which have become generally known indicate that, in principle, paint can also be atomized by means of ultrasonic standing-wave atomization. Following these considerations of the principles concerned, however, average droplet sizes during atomization of between 100 μm. and 200 μm. have been measured, with some instances of still larger drops occurring. However, large drops of this kind adversely influence the quality of the coat of paint in such a way as to make use in painting technology unattractive.

It has been proposed how an ultrasonic standing-wave atomizer arrangement for producing a paint spray mist for painting a workpiece can be designed to achieve smaller droplet sizes. For example, specific designs of the sonotrode and of the component, shut-off elements or multi-piece rings, which improve the quality of the paint spray mist produced and consequently allow comparatively small droplet sizes to be achieved, have become known. A disadvantage is that only comparatively low delivery rates of paint can be atomized by the arrangement that has become known.

On the basis of this prior art, it is the object of the invention to provide an ultrasonic standing-wave atomizer arrangement for producing a paint spray mist with which it is possible to increase the atomized amount of paint, that is the rate of paint, and at the same time to maintain a selected range of droplet sizes occurring.

This object is achieved by the ultrasonic standing-wave atomizer arrangement according to the invention for producing a paint spray mist for painting a workpiece with the features specifed in Claim 1.

The ultrasonic standing-wave atomizer arrangement according to the invention, of the type stated at the beginning, accordingly has a paint-feeding device, which has in the region of the standing ultrasonic field at least two pieces of pipe for discharging paint. Moreover, at least two of the pieces of pipe are arranged in the region of a selected maximum of the sound particle velocity of the standing ultrasonic field. According to the invention, it is therefore provided that a selected maximum of the sound particle velocity of a standing ultrasonic wave is used for the purpose of atomizing a comparatively large amount of paint into paint droplets. This is so because it has been found that, in particular in the case of ultrasonic standing-wave atomizer arrangements of a simple construction, a selected maximum of the sound particle velocity is often particularly well formed in the standing ultrasonic field, for example in the case of standing ultrasonic fields with an uneven number of sound particle velocity antinodes, the middle sound particle velocity antinode. That is to say that this maximum is particularly stable, with a comparatively high sound particle velocity. These particularly good atomizing properties of the selected maximum are used according to the invention for increasing the amount of paint to be atomized or the flow of paint through the paint-feeding device and it is provided that at least two pieces of pipe for discharging paint are arranged in the region of the selected maximum. Consequently, the amount of paint to be atomized can be increased in an advantageous way. An advantageous design of the ultrasonic standing-wave atomizer arrangement according to the invention is achieved if the component is a further sonotrode. In this way, the atomizing capability of the standing ultrasonic field can be increased. Moreover, a more stable ultrasonic field can be formed in this way.

A further advantageous refinement of the subject-matter of the invention provides that the distance between the pieces of pipe in the region of the selected maximum is so great that sheets of paint that are separate from one another are formed for each piece of pipe. For technical vibration-related reasons, a sheet of paint is respectively formed in any case on the pieces of pipe, extending from the paint outlet point. If the distance between the pieces of pipe has been chosen to be great enough that the sheets of paint can form separately from one another without influencing one another, the region in which droplets of different sheets of paint collide and in this way can recombine to form larger droplets is avoided in any case. The quality of the paint spray mist is improved with the proposed arrangement.

It is particularly advantageous if the paint outlet openings of the at least two pieces of pipe in the region of the selected maximum of the sound particle velocity of a standing ultrasonic wave are arranged on a straight line, and if the straight line is perpendicular to an imaginary centre line which passes through the centroids of the opposing sound faces of the sonotrode and of the component. In the case of an arrangement of this type, the distance between the paint outlet points on the pieces of pipe and the sonotrode or the component are respectively of approximately the same size. A particularly advantageous position, seen in the X direction, is achieved in the region of the maximum of the sound particle velocity.

The advantage mentioned above may also be achieved if three pieces of pipe are arranged in the region of a selected maximum of the sound particle velocity of a standing ultrasonic wave, and if these pieces of pipe or their paint outlet openings are arranged in a triangle. An arrangement in an equilateral triangle is particularly favourable. It is a further improvement if that area which is determined by the triangle is perpendicular to an imaginary centre line which passes through the centroids of the opposing sound faces of the sonotrode and of the component. In this case, too, the effect is in turn achieved that, seen in the X direction, the paint outlet openings are situated in the region of the maximum of the sound particle velocity.

It has also been found that the atomizing operation or the atomizing rate can be improved by choosing the specific maximum such that it is closer to the sonotrode than to the component. There is then the possibility of the so-called capillary wave turbulence effect, that is to say the effect which keeps the paint droplets away from the sonotrode as a result of the vibrations of the latter and in this way assists the atomization process.

Further advantageous refinements of the subject-matter of the invention can be taken from the dependent claims.

The invention, its advantages and further improvements of the invention are explained and described in more detail on the basis of the example embodiments specified in the drawings, in which:

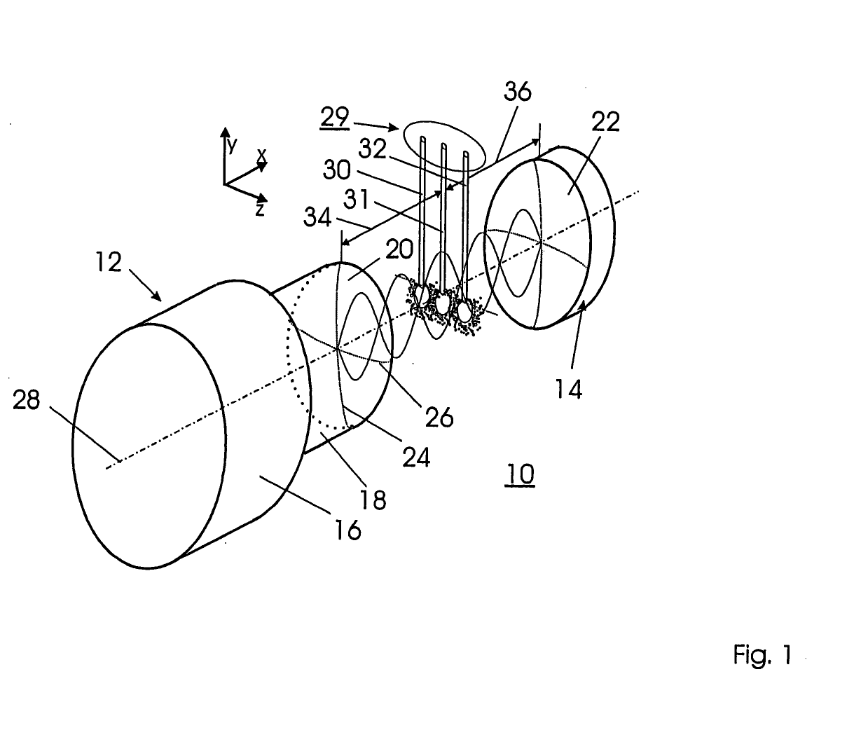

FIG. 1 shows a first ultrasonic standing-wave atomizer arrangement,

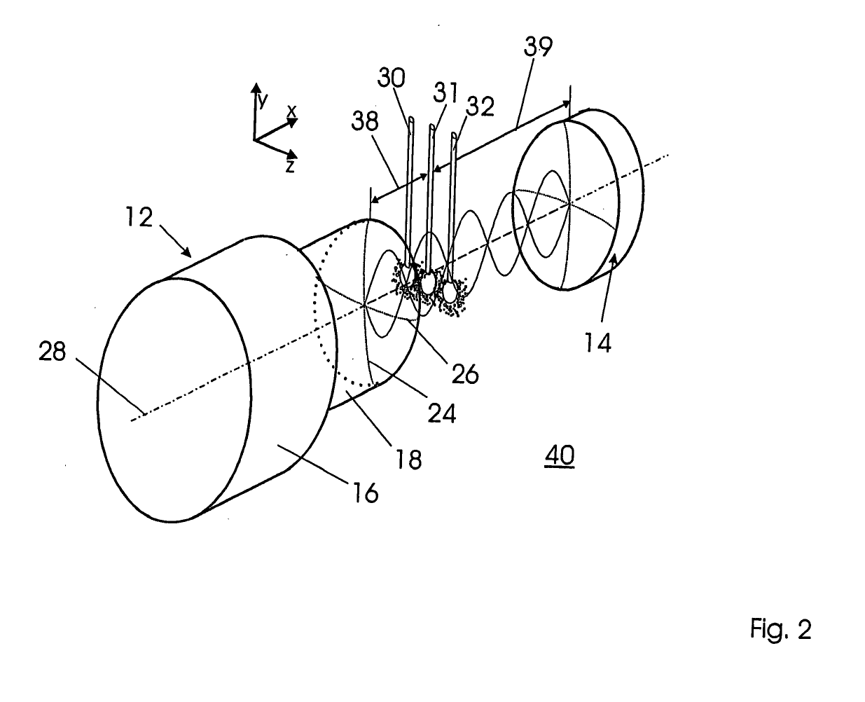

FIG. 2 shows a second ultrasonic standing-wave atomizer arrangement,

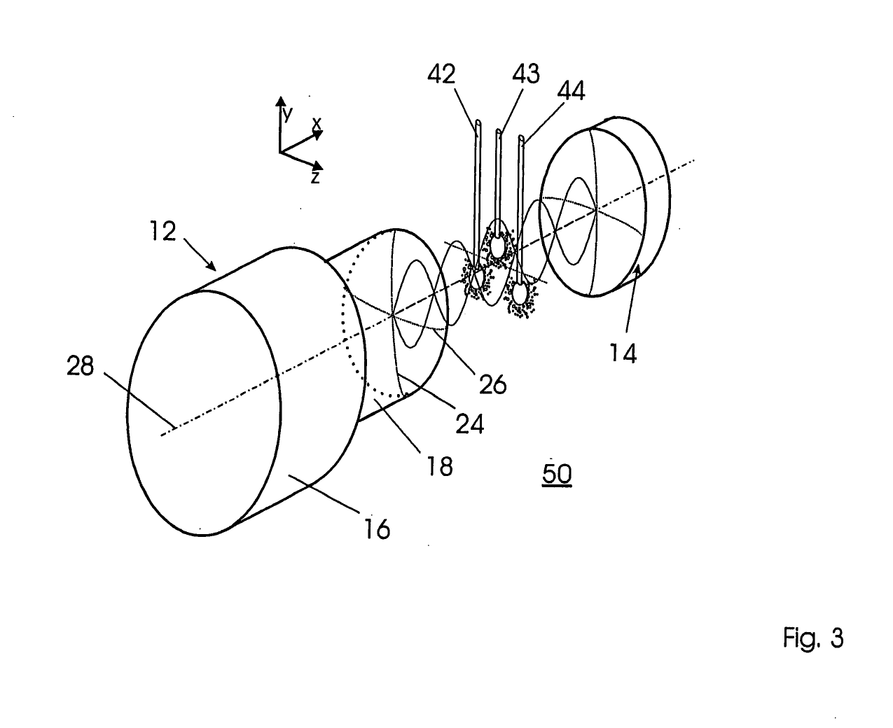

FIG. 3 shows a third ultrasonic standing-wave atomizer arrangement,

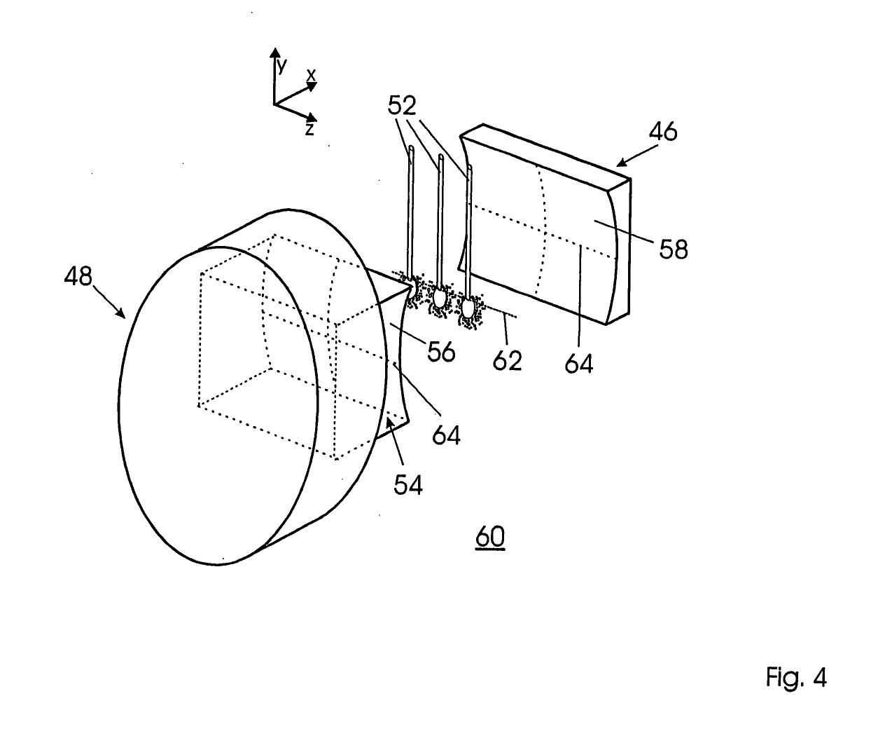

FIG. 4 shows a fourth ultrasonic standing-wave atomizer arrangement,

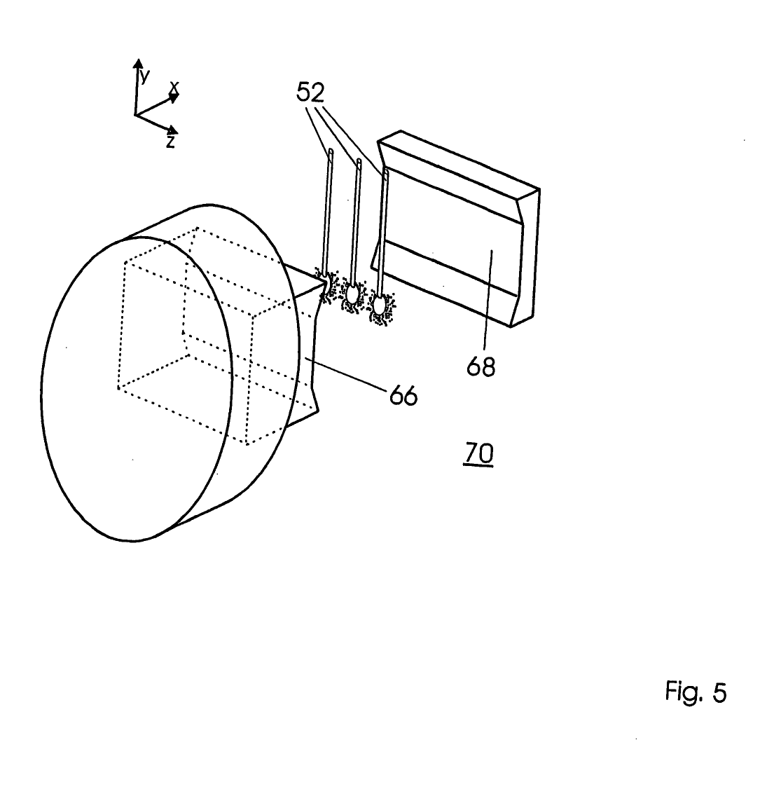

FIG. 5 shows a fifth ultrasonic standing-wave atomizer arrangement,

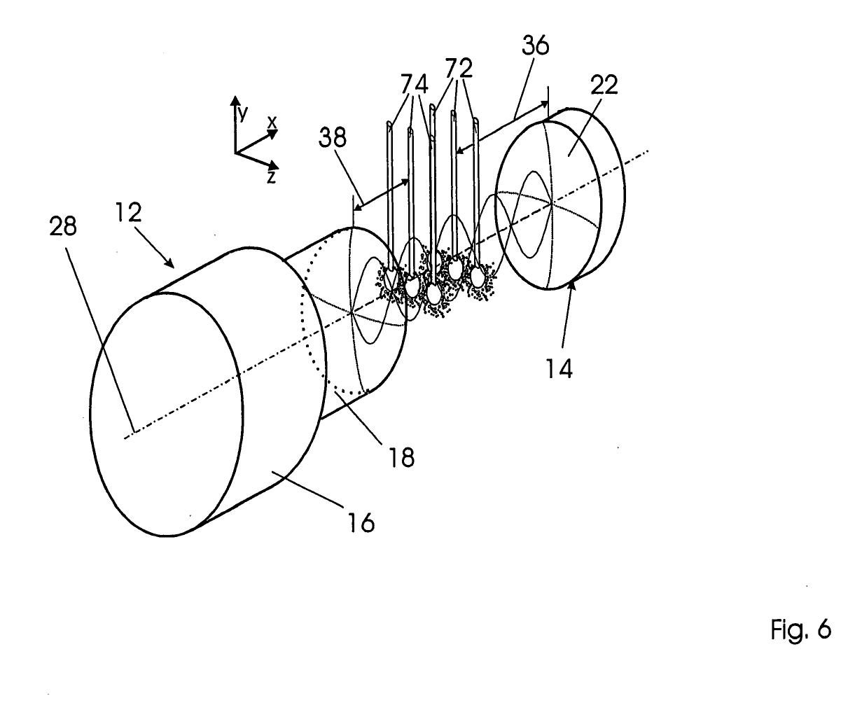

FIG. 6 shows a sixth ultrasonic standing-wave atomizer arrangement.

FIG. 1 shows a first ultrasonic standing-wave atomizer arrangement 10 according to the invention in an isometric representation. The coordinates are indicated by the directional arrows for the X, Y and Z directions in a system of Cartesian coordinates. Moreover, the representation is intended to be only of a schematic character, with the result that the actual relative sizes cannot be taken from this figure.

A first sonotrode 12 is arranged lying opposite a first reflection body 14. In this figure, the sonotrode 12 is schematically represented by a cylindrical basic body 16 and a sound body 18, which protrudes from the end face of the cylindrical basic body 16 facing towards the reflection body 14. The sound body 18 and the basic body 16 have an approximately cylindrical form. The opposing end faces of the sound body 18 and of the first reflection body 14 are to be referred to as the first sound face 20 for the end face on the sound body 18 and as the second sound face 22 for the end face on the reflection body 14. The first sound face 20 and the second sound face 22 are concavely formed, that is to say their form corresponds approximately to a portion of the surface of an imaginary hollow sphere. To illustrate this form, a first dotted line 24 and a second dotted line 26 have been drawn on the first sound face 20. The point of intersection between the first line 24 and the second line 26 lies exactly centrally on the first sound face 20. Lines corresponding to the first line 24 and the second line 26 are also shown on the second sound face 22, without however being provided more specifically with reference numerals. Also shown through the point of intersection of the first line 24 with the second line 26 and also the corresponding lines of the second sound face 22 is a centre axis 28, which runs exactly in the direction of the X coordinate.

Shown in the intermediate space between the first sound face 20 and the second sound face 22 is a first piece of pipe 30, a second piece of pipe 31 and a third piece of pipe 32, the free ends of which are arranged exactly midway between the sound faces 20, 22. That is to say that the pieces of pipe 30, 31, 32 are arranged next to one another, the free ends all lying in one plane, which is defined by the centre axis 28 and the second line 26. Moreover, all the free ends can be joined by an imaginary straight line. The longitudinal axes of the pieces of pipe 30, 31, 32 are arranged parallel to the Y direction and are connected by their ends remote from the ends to a paint-feeding device 29 (not represented any more specifically in this figure), which provides the required amount of paint to be atomized by the first ultrasonic standing-wave atomizer arrangement 10. However, the idea of the invention also includes the option of each of the pieces of pipe 30, 31, 32 being respectively connected to a separate paint-feeding device 29. This is in any event also to be intended by the paint-feeding device 29 described here.

The other end of the pieces of pipe 30, 31, 32 therefore ends as it were in “free space”, without which the connection to the paint-feeding device 29 would be represented.

To allow better illustration of the processes taking place in the standing ultrasonic field between the first sound face 20 and the second sound face 22, the profiles of five sound particle velocity antinodes of the standing ultrasonic wave have been shown in the intermediate space, the profiles being represented about the centre axis 28, to be precise in the plane defined by the X direction and Y direction. In the example chosen, a first distance 34 between the first sound face 20 and the pieces of pipe 30, 31, 32 and a second distance 36 between the pieces of pipe 30, 31, 32 and the second sound face 22 are of the same size. It is consequently clear that the free ends concerned of the pieces of pipe 30, 31, 32 are also situated at only one maximum of the sound particle velocity, that is to say in the middle one of the five sound particle velocity antinodes. In the design of the first ultrasonic standing-wave atomizer arrangement 10 that has been chosen for this arrangement, a first distance 34 and a second distance 36 of 17 mm are obtained for an ultrasonic frequency of 24 kHz and five sound particle velocity antinodes. That is to say that adequate space is available for cleaning or directing air which is possibly used for assisting the atomization process or for directing the particles of paint. With such an arrangement of three pieces of pipe 30, 31, 32 in only one sound particle velocity antinode, that is in the region of a maximum of sound particle velocity, the advantageous effect is therefore achieved that particularly high rates of paint, in particular rates of paint of more than 200 ml/min, are readily achievable. Moreover, it is ensured that the distribution of the diameters of the drops of atomized paint remain in an acceptable range. The atomizing operation is only symbolically represented in this figure at the respective free ends of the pieces of pipe 30, 31, 32, in that many small paint particles are indicated around an exaggerated atomization bubble.

FIG. 2 shows a second ultrasonic standing-wave atomizer arrangement 40, which is intended to have substantially the same components as the first ultrasonic standing-wave atomizer arrangement 10, for which reason the same reference numerals have been chosen for equivalent components. A major difference between the first ultrasonic standing-wave atomizer arrangement 10 and the second ultrasonic standing-wave atomizer arrangement 40 is that, unlike in the arrangement shown in FIG. 1, the arrangement of the pieces of pipe 30, 31, 32 no longer takes place midway between the sound body 18 and the first reflection body, but closer to the sound body 18. The arrangement of the pieces of pipe 30, 31, 32 is chosen such that their paint outlet openings in turn come to lie at a selected maximum of the sound particle velocity of the standing ultrasonic wave, to be precise at the second maximum shown, as seen from the sound body 18. That is to say therefore that a third distance 38 between the sound body 18 and the pieces of pipe 30, 31, 32 is less than a fourth distance 39, which is determined as the distance between the pieces of pipe 30, 31, 32 and the first reflection body 14. In the case of the arrangement shown here, it proves to be an advantage that the pieces of pipe 30, 31, 32 lie closer to the first sonotrode 12. This is so because it has been found that the vibrations of the sound body 18 of the first sonotrode 12 stop the atomized paint droplets comparatively well from adhering to the sonotrode due to the vibration of the sound body 18 itself. Or to put it another way, the vibrations of the sound body 18 keep the paint droplets away from it.

In addition, the representation of the pieces of pipe 30, 31, 32 and the atomization bubbles indicated with the atomized paint particles show that the distance between the pieces of pipe 30, 31, 32 is chosen such that atomizing regions that respectively operate independently of one another form at the free ends of the pieces of pipe 30, 31, 32, that is to say that sheets of paint that are separate from one another are formed for each piece of pipe 30, 31, 32. This has the advantage that the regions in which the discharged paint is atomized into particles do not disturb one another. Consequently, the atomizing operation is improved and a comparatively high atomizing rate is achieved.

FIG. 3 shows a further advantageous possibility for refining the subject-matter of the invention, with a third ultrasonic standing-wave atomizer arrangement 50, which is of a substantially similar construction to that of the first ultrasonic standing-wave atomizer arrangement 10. To make it easier to compare between the components used, the same reference numerals have therefore been used in turn for comparable components.

A major difference between the arrangement in this figure and that in FIG. 1 is that in this figure a fourth piece of pipe 42, a fifth piece of pipe 43 and a sixth piece of pipe 44 are arranged exactly midway between the sound body 18 and the first reflection body 14. Although the corresponding paint outlet openings of the pieces of pipe 412, 43, 44 are accordingly arranged in turn in the region of the central maximum of sound particle velocity, the paint outlet openings no longer lie in the plane defined by the X and Z directions, but instead the middle, fifth piece of pipe 43 lies in the positive Y direction, above the plane defined by the X and Z directions, while the fourth piece of pipe 42 and the sixth piece of pipe 44 lie underneath the plane defined by the X and Z directions. However, all three paint outlet openings still lie together in a plane parallel to a plane defined by the Y and Z directions. The three paint outlet openings therefore form as it were an imaginary triangle which is situated in a plane parallel to the plane defined by the Y and Z directions. This design has the advantage that the distance between the paint outlet openings can be further increased without leaving the chosen, one maximum of the sound particle velocity. In this way, the atomization can be further improved and at the same time the rate of paint can also be increased.

FIG. 4 shows a fourth ultrasonic standing-wave atomizer arrangement 60 with a second reflection body 46, which is arranged lying opposite a second sonotrode 48. Three first small paint pipes 52 are in turn arranged midway between the second reflection body 46 and the second sonotrode 48. In a way similar to that already shown in FIG. 1, the paint outlet openings of the first small paint pipes are aligned along an imaginary line in the Z direction. A special feature of the arrangement shown is that a second sound body 54 on the second sonotrode 48 and also the second reflection body 46 have approximately a cuboidal form, the opposing sound faces of the second sound body 54 and of the second reflection body 46, that is to say the third sound face 56 on the second sound body 54 and the fourth sound face 48 on the second reflection body 46, having a form which corresponds to a portion of the generated surface of a cylindrical body.

In this case, it proves to be an advantage if the imaginary centre axis of the cylindrical body runs parallel to that line 62 which runs through the paint outlet openings of the first small paint pipes 52. The projections 64 of the centre axis of the imaginary cylinder on the third sound face 56 and on the fourth sound face 58 are drawn as dotted lines. Such an arrangement achieves the effect that the maximum of the sound particle velocity in the stationary ultrasonic field is as wide as possible, that is to say it has an extent which is as great as possible in the direction of the line 62, which coincides here with the Z direction.

A fifth ultrasonic standing-wave atomizer arrangement 70 is shown in FIG. 5. In this case, the arrangement shown is similar to that from FIG. 4, with the result that the second small paint pipes 52 are in turn arranged midway between a fifth sound face 66 and a sixth sound face 68. As a difference from the sound faces shown in FIG. 4, the fifth sound face 66 and the sixth sound face 68 are made up of planar subfaces, the form of which however resembles a portion of the generated surface of a cylindrical body. In this way too, widening of the region of the maximum sound particle velocity in the standing ultrasonic field is likewise achieved.

Finally, FIG. 6 shows a sixth ultrasonic standing-wave atomizer arrangement, which is based on the arrangement of the first sonotrode 12 with the first reflection body 14, as shown in FIG. 1. The reference numerals have been correspondingly taken over from FIG. 1. In this case, three second small paint pipes 72 are arranged in a way corresponding to the pieces of pipe 30, 31, 32, as shown in FIG. 1, and therefore have an equal distance from the sonotrode 12 and from the first reflection body 14, which is shown here by indicating the second distance 36. Also shown in this figure are three third small paint pipes 74, which are shown in the position which corresponds to the position of the pieces of pipe 30, 31, 32 in FIG. 2. That is to say that the distance between the third small paint pipes 74 and the sound body 18 corresponds to the third distance 38 according to FIG. 2. This is correspondingly drawn in this figure. In this refinement of the subject-matter of the invention, it is therefore provided that a total of six small paint pipes 72, 74 are arranged between the first sonotrode 12 and the first reflection body 14, to be precise respectively in two groups of in each case three small paint pipes 72, 74, with the result that three small paint pipes 74 are respectively arranged at the second maximum of the sound particle velocity, proceeding from the sound body 18, and three small paint pipes 72 are arranged at the third maximum, and consequently over the maximum of sound particle velocity. With such an arrangement, the rate of the paint atomization can be increased still further.

In none of the arrangements given above as examples was it shown in detail which further measures can act favourably on the atomization or on the painting process as such. For example, cleaning air can be used in the generally known way for substantially avoiding adherence of atomized paint to the sonotrode or to the reflection body. In addition, directing air can be used to make the atomized paint particles preferably fly in the desired direction of painting. The process of directed painting can also be assisted by the paint particles being electrostatically charged. This charging may be achieved internally, in the generally known way, that is to say with paint that is at a high-voltage potential being fed in, or by what is known as external charging, which usually charges the atomized paint through needles which carry a high voltage and are arranged in the vicinity of the atomizing location. The workpiece to be painted is then usually connected to earth potential, so that the electrically charged paint particles preferably fly towards the workpiece. A combination of internal and external charging is also quite possible.

Otherwise, it is quite conceivable that the reflection body is a further sonotrode, with the particular advantage that the standing ultrasonic field can be formed particularly strongly. Moreover, such a measure improves the controllability of the ultrasonic field.

### LIST OF DESCRIPTION

10 first ultrasonic standing-wave atomizer arrangement
12 first sonotrode
14 first reflection body
16 basic body
18 first sound body
20 first sound face
22 second sound face
24 first line
26 second line
28 centre axis
30 first piece of pipe
31 second piece of pipe
32 third piece of pipe
34 first distance
36 second distance
38 third distance
39 fourth distance
40 second ultrasonic standing-wave atomizer arrangement
42 fourth piece of pipe
43 fifth piece of pipe
44 sixth piece of pipe
46 second reflection body
48 second sonotrode
50 third ultrasonic standing-wave atomizer arrangement
52 first small paint pipes
54 second sound body
56 third sound body
58 fourth sound body
60 fourth ultrasonic standing-wave atomizer arrangement.
62 line
64 projections
66 fifth sound face
68 sixth sound face
70 fifth ultrasonic standing-wave atomizer arrangement
72 second small paint pipes
74 third small paint pipes
80 sixth ultrasonic standing-wave atomizer arrangement

1. Ultrasonic standing-wave atomizer arrangement for producing a paint spray mist for painting a workpiece, with a sonotrode, with a component arranged lying opposite the sonotrode, a standing ultrasonic field being formed in the intermediate space between the sonotrode and the component in the case of operation, and with a paint-feeding device, by means of which paint can be fed into the vicinity of a maximum of the sound particle velocity of the ultrasonic field, wherein the paint-feeding device has in the region of the standing ultrasonic field at least two pieces of pipe for discharging paint, and in that at least two of the pieces of pipe are arranged in the region of a selected maximum of the sound particle velocity of the standing ultrasonic field.

2. Ultrasonic standing-wave atomizer arrangement according to claim 1, wherein the component is a further sonotrode.

3. Ultrasonic standing-wave atomizer arrangement according to claim 1, wherein the distance between the pieces of pipe in the region of the selected maximum is so great that sheets of paint that are separate from one another are formed for each piece of pipe.

4. Ultrasonic standing-wave atomizer arrangement according to claim 1, wherein the paint outlet openings of the at least two pieces of pipe in the region of the selected maximum of the sound particle velocity of a standing ultrasonic wave are arranged on an imaginary straight line, and in that the straight line is perpendicular to an imaginary centre line which passes through the centroids of the opposing sound faces of the sonotrode and of the component.

5. Ultrasonic standing-wave atomizer arrangement according to claim 4, wherein the shape of the sound faces corresponds approximately to a segment of the generated surface of a cylinder reproduced with polyhedral surfaces, or the segment is cylindrical, and in that the longitudinal axis of the cylinder concerned is situated parallel to the straight line.

6. Ultrasonic standing-wave atomizer arrangement according to claim 1, wherein three of the pieces of pipe are arranged in the region of a selected maximum of the sound particle velocity of a standing ultrasonic wave, and in that these pieces of pipe or their paint outlet openings are arranged in a triangle, in particular an equilateral triangle.

7. Ultrasonic standing-wave atomizer arrangement according to claim 6, wherein the surface which is determined by the triangle is perpendicular to an imaginary centre line which passes through the centroids of the opposing sound faces of the sonotrode and of the component.

8. Ultrasonic standing-wave atomizer arrangement according to claim 1, wherein the distance between the at least two pieces of pipe arranged in the region of a selected maximum of the sound particle velocity of a standing ultrasonic wave and the sonotrode is at most equal to the distance between these pieces of pipe and the component.

9. Ultrasonic standing-wave atomizer arrangement according to claim 1, wherein the at least two pieces of pipe are provided with a hydrophobic surface, in particular a tetrafluoroethylene coating.

10. Ultrasonic standing-wave atomizer arrangement according to claim 1, wherein there is a flow of cleaning air, by which wetting of the sonotrode and/or of the component is avoided or reduced.

11. Ultrasonic standing-wave atomizer arrangement according to claim 1, wherein there is a flow of directing air, by which the direction of flight of the paint spray mist can be influenced.

12. Ultrasonic standing-wave atomizer arrangement according to claim 1, wherein there is at least one charging device for internal and/or external charging, by which the paint or the atomized paint particles can be electrostatically charged.
